(19) United States
(12) Patent Application Publication
(10) Pub. No.: US 2009/0141605 A1
(43) Pub. Date: Jun. 4, 2009

(54) OPTICAL DISC REPRODUCING DEVICE AND OPTICAL DISC REPRODUCING METHOD

(75) Inventors: Yukiyasu TATSUZAWA, Yokohama-shi (JP); Hideyuki YAMAKAWA, Yokohama-shi (JP); Norikatsu CHIBA, Kawasaki-shi (JP); Toshihiko KANESHIGE, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/276,136

(22) Filed: Nov. 21, 2008

(30) Foreign Application Priority Data
Nov. 30, 2007 (JP) 2007-310974

(51) Int. Cl. G11B 27/30

(52) U.S. Cl. 369/59.21; G9B/7.122

(57) ABSTRACT

An optical disc reproducing device is provided which is capable of setting an optimum PR class for the comprehensive frequency characteristic of an optical disc including the recording characteristic and reproducing characteristic. An optical disc reproducing device according to the present invention relates to an optical disc reproducing device which performs reproduction from an optical disc using the PRML method. The optical disc reproducing device comprises a Viterbi decoding unit which generates binary data using maximum likelihood decoding processing based upon multi-value reproduced data obtained by sampling a reproduced signal from the optical disc. The Viterbi decoding unit generates the binary data based upon an optimum PR class determined based upon the multi-value reproduced data and the binary data in a predetermined determination period.

### CROSS-REFERENCE TO RELATED APPLICATIONS

This application claims the benefit of priority of Japanese Patent Application No. 2007-310974, filed Nov. 30, 2007, the entire contents of which are incorporated herein by reference.

### BACKGROUND

1. Field

The present invention relates to an optical disc reproducing device and an optical disc reproducing method, and particularly to a recording medium reproducing device which performs A/D conversion of a reproduced signal so as to process the reproduced signal, and a reproducing method thereof.

2. Description of the Related Art

Recently, HD DVD players for purpose of playing back HD (High Definition) video data, stipulated by the large capacity optical disc standard, have been marketed. These HD DVD players perform readout operation using a blue-violet laser beam with a wavelength of 405 nm. According to the read-only HD DVD-ROM standard, each single-sided medium having a single layer provides a recording capacity of 15 GB. Furthermore, each single-sided medium having two layers provides a recording capacity of 30 GB. According to the rewritable HD DVD-RAM standard, each medium having a single layer provides a recording capacity of 20 GB. In order to achieve such a large recording capacity, the HD DVD standard employs the PRML (Partial Response and Maximum Likelihood) technique as a signal processing method for data reproduction, in addition to techniques for providing short-wavelength lasers.

The PRML technique has been disclosed in JP-A 2005-158240, JP-A 2005-346847 and JP-A 2004-327013, for example. Brief description will be made below regarding the PRML technique.

Partial response (PR) is a method for compressing the necessary signal band actively using inter-symbol interference (interference that occurs between the reproduced signals that correspond to the bits recorded adjacent one another), so as to reproduce data. The partial response can be classified into multiple kinds of classes based upon the patterns of inter-symbol interference thus generated. For example, in a case in which the partial response with class 1 is employed, when the recorded data is “1”, the reproduced data “11” is obtained in the form of two-bit data. That is, for the partial response with class 1, the recorded data generates inter-symbol interference which affects the subsequent one bit. The Viterbi decoding method (ML) is a so-called a kind of maximum likelihood sequence estimation methods. In the Viterbi decoding method, the data is reproduced based upon the information with respect to signal amplitude over multiple points in time, effectively using regularity in the inter-symbol interference involved in the reproduced waveform. In order to perform this processing, a synchronous clock signal is generated synchronously with the reproduced waveform acquired from the recording medium. Furthermore, sampling processing is performed on the reproduced waveform using the clock signal thus generated, thereby converting the reproduced waveform into amplitude information.

Subsequently, suitable waveform equalization is performed so as to convert the reproduced waveform into a predetermined partial response waveform. Furthermore, a Viterbi decoding unit obtains a maximum likelihood data sequence based upon past and current sample data sets, and outputs the data sequence thus obtained as reproduced data. Such a combination of the partial response method and the Viterbi decoding method (maximum likelihood decoding) as described above is referred to as “PRML” method. Practical application of the PRML technique requires the high-precision adaptive equalization technique which enables a reproduced signal to be converted into a response signal in a predetermined PR class, and the high-precision clock reproducing technique which supports the former technique.

Next, description will be made regarding a run-length limited code employed in the PRML technique. A PRML reproducing circuit generates a clock signal synchronously with a reproduced signal obtained from a recording medium, based upon the reproduced signal itself. In order to generate a stable clock signal, a recorded signal must change its polarity within a predetermined period of time. Furthermore, in order to reduce the maximum frequency of the recorded signal, the polarity of the recorded signal should not change during another period of time. Here, the maximum data length, in which the polarity of the recorded signal does not change, will be referred to as “maximum run length”. On the other hand, the minimum data length, in which the polarity of the recorded signal does not change, will be referred to as “minimum run length”.

For example, the modulation rule for handling data with the maximum run length of 7 bits and the minimum run length of 1 bit is referred to as “(1,7) RLL”. A code according to the (1,7) RLL modulation rule has a feature that, with the unit length of the code as “T”, the minimum value (Tmin) in which the same symbols are consecutively recorded is represented by “2 T”. Accordingly, such a code is also referred to as “2 T-system code”.

Also, the modulation rule for handling data with the maximum run length of 7 bits and the minimum run length of 2 bit is referred to as “(2,7) RLL”. A code according to the (2,7) RLL modulation rule has a feature that Tmin is represented by “3 T”. Accordingly, such a code is also referred to as “3 T-system code”.

Examples of typical modulation/demodulation methods employed in optical discs include: ETM (Eight to Twelve Modulation) for a 2 T-system code, which is employed in HD DVD; and 8/16 modulation (EFM plus) for a 3 T-system code, which is employed in conventional DVDs.

It is expected that reproducing processing for optical discs, into which the aforementioned PRML technique is introduced, will provide markedly improved reproducing performance, in particular, as compared with conventional binary-slicing reproducing processing when data is recorded with high density. Accordingly, the PRML technique has been employed in the HD DVD standard, thereby markedly improving the track recording density.

Furthermore, the PRML technique is also effectively applied to CDs which are conventional optical discs, and conventional DVDs, etc. It is expected that the PRML technique will improve the reproducing performance such as the reduced error rate, etc. Accordingly, in many cases, the PRML signal processing circuit for reading the HD DVD has a mode for handling conventional DVD reproduction. With such an arrangement, the PRML technique is also applied to the conventional DVD, thereby improving the reproducing performance.

However, the CD and the conventional DVD, which are stipulated by standards that differ from that of the HD DVD, have optical disc frequency characteristics (MTF (Mutual Transfer Function) characteristics) that differ from that of the HD DVD. This leads to a problem in that there is difference in the kind of the optimum PR class among the different kinds of the optical disc standards.

JP-A 2005-158240 discloses a technique which allows multiple optical discs stipulated by different standards to be reproduced in a single reproducing device. With the technique disclosed in JP-A 2005-158240, a Viterbi decoder having a function of handling multiple PR classes is included. With such an arrangement, a type signal, which is defined for each optical disc standard, is read out from an optical disc, and the PR class, which is to be used by the Viterbi decoder, is selected according to the type signal.

In general, the PRML method requires the condition that the MTF characteristic matches the frequency characteristic of the PR class with high precision. The term “MTF characteristic” as used here does not represent only the MTF characteristic of the optical disc, but represents the comprehensive frequency characteristic including the frequency characteristic of the reproducing device such as the frequency characteristic of an optical pickup, etc., in addition to the MTF characteristic of the optical disc. Accordingly, in some cases, change in the reproducing device leads to change in the MTF characteristic, even if the same optical disc is subjected to reproduction.

With recordable optical discs, in many cases, so-called recording learning is performed in order to set the optimum values of the recording power, recording waveform, etc. The method of the recording learning also affects the frequency characteristic. Accordingly, in a case in which recording is performed using different optical disc devices, there may be, in some cases, a difference in the MTF characteristic between the optical discs, even if the optical discs are stipulated by the same standard and are reproduced by the same reproducing device.

For example, it is said that the MTF characteristics of HD DVD-ROM (read-only optical disc) and HD DVD-R (recordable optical disc) are closest to the frequency characteristic of a particular PR class which is called the PR(3443). Accordingly, when reproduction operation is performed for such an optical disc, in many cases, the RR class is set to the PR(3443). However, the recording learning is performed on HD DVD-R. Thus, in some cases, recording learning is performed to provide the frequency characteristic close to one of other PR classes, e.g., PR(12221). Accordingly, in some cases, the MTF frequency thus obtained differs from that of the predetermined PR(3443).

Even in such a case, the difference in frequency characteristic can be absorbed to a certain extent by means of an adaptive equalization device. However, in a case in which the difference between the actual MTF characteristic and the frequency characteristic of the PR class thus set beforehand is large, excessive high-frequency boost occurs, thereby reducing the quality of the reproduced signal.

The technique disclosed in JP-A 2005-158240 provides a method for selecting and switching the PR class based upon the kind of the optical disc standard. Accordingly, this technique does not support the change in the MTF characteristic which depends on the reproducing device such as the optical pickup, etc., and the difference in the MTF characteristic due to the recording learning method.

### SUMMARY OF THE INVENTION

The present invention has been made in view of the aforementioned situations. Accordingly, it is an object of the present invention to provide an optical disc reproducing device which is capable of setting an optimum PR class for the comprehensive frequency characteristic of the optical disc including the recording characteristic and the reproducing. characteristic, and an optical disc reproducing method thereof.

In order to solve the aforementioned problems, according to an aspect of the invention, an optical disc reproducing device according to the present invention relates to an optical disc reproducing device which performs reproduction from an optical disc using the PRML method. The optical disc reproducing device comprises a Viterbi decoding unit which generates binary data using maximum likelihood decoding processing based upon multi-value reproduced data obtained by sampling a reproduced signal from the optical disc. With such an arrangement, the Viterbi decoding unit generates the binary data based upon an optimum PR class determined based upon the multi-value reproduced data and the binary data in a predetermined determination period.

Also, according to another aspect of the invention, an optical disc reproducing method according to the present invention relates to an optical disc reproducing method for performing reproduction from an optical disc using the PRML method. The optical disc reproducing method comprises a step for generating binary data using maximum likelihood decoding processing by means of Viterbi decoding processing based upon multi-value reproduced data obtained by sampling a reproduced signal from the optical disc. With such an arrangement, in the step for generating binary data, the binary data is generated based upon an optimum PR class determined based upon the multi-value reproduced data and the binary data in a predetermined determination period.

An optical disc reproducing device and an optical disc reproducing method according to the present invention allow an optimum PR class to be set for the comprehensive frequency characteristic including the recording characteristic and reproducing characteristic.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram which shows a configuration example of an optical disc reproducing device according to a first embodiment of the present invention;

FIG. 2 is a diagram which shows the relation between an MTF characteristic and a frequency characteristic of a predetermined PR class;

FIG. 3A is a diagram which shows an example of the frequency characteristics of a pre-equalizer in a normal reproducing mode;

FIG. 3B is a diagram which shows an example of the frequency characteristics of a pre-equalizer in an optimum PR class determination mode;

FIG. 4 is a diagram for describing the mechanism of the operation of an adaptive equalization unit;

FIG. 5 is a diagram which shows a configuration example of an optimum PR class determination unit;

FIG. 6 is a diagram which shows a configuration example of an optical disc reproducing device according to a second embodiment of the present invention;

FIG. 7 is a diagram which shows a configuration example of an adaptive Viterbi decoding unit;

FIG. 8 is a Trellis diagram according to the PR(1221) class using data with the minimum run length of 1;

FIG. 9 is a diagram which shows a configuration example of a reference value optimization processing unit; and

FIG. 10 is a diagram which shows a configuration example of an optical disc reproducing device according to a third embodiment of the present invention.

### DETAILED DESCRIPTION

Description will be made with reference to the accompanying drawings regarding an optical disc reproducing device and an optical disc reproducing method according to an embodiment of the present invention.

### (1) First Embodiment

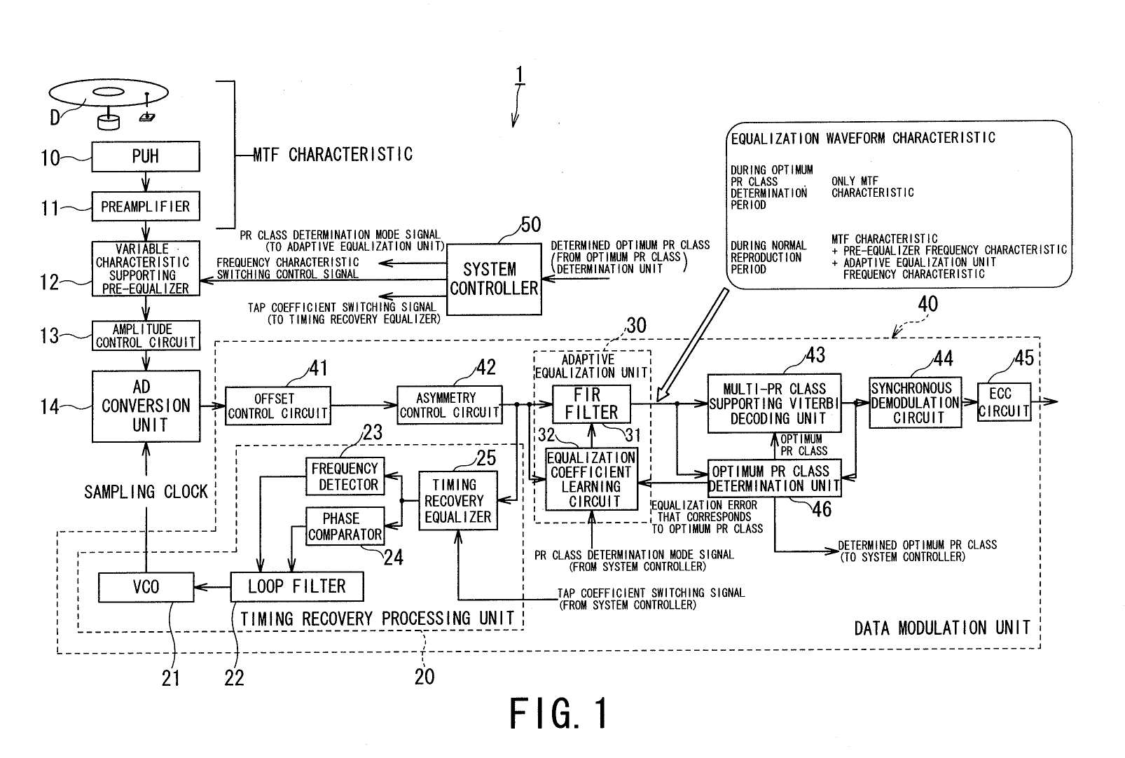

FIG. 1 is a diagram which shows a configuration example of an optical disc reproducing device 1 according to a first embodiment. As shown in FIG. 1, the optical disc reproducing device 1 includes: an optical pickup 10 (which will be referred to as “PUH (Pickup Head) 10” hereafter); a preamplifier 11; a variable-characteristic supporting pre-equalizer 12; an amplitude control circuit 13, an AD conversion unit 14, a data decoding unit 40, and a system controller 50.

The data decoding unit 40 has an internal configuration including a timing recovery processing unit 20, an offset control circuit 41, an asymmetry control circuit 42, an adaptive equalization unit 30, a multi-PR class supporting Viterbi decoding unit 43, a synchronous demodulation circuit 44, an ECC circuit 45, an optimum class determination unit 46, and so forth.

Furthermore, the timing recovery processing unit 20 has an internal configuration including a VCO 21, a loop filter 22, a frequency detector 23, a phase comparator 24, and a timing-recovery equalizer 25. Moreover, the adaptive equalization unit 30 has an internal configuration including an FIR filter 31 and an equalization coefficient learning circuit 32.

The optical disc reproducing device 1 according to the first embodiment has a configuration which allows the Viterbi decoding unit 43 to support multiple PR classes. With such an arrangement, in a predetermined determination period, the optimum PR class is selected and determined from among the multiple PR classes. In the reproduction step after the determination period, the optimum PR class thus selected is set for the Viterbi decoding unit 43 so as to decode the reproduced data.

The kinds and number of the multiple PR classes are not restricted in particular. Description will be made below regarding an arrangement using two PR classes, i.e., the PR(3443) class and the PR(12221) class.

The predetermined determination period is a part of the initial operation period immediately after an optical disc is inserted into the optical disc reproducing device 1, for example. In the determination period, the operation mode of the optical disc reproducing device 1 is set to the “optimum PR class determination mode”. Then, reproduction operation is actually performed for the optical disc in the optimum PR class determination mode thus set. In this example, comparison determination is made between the data reproduced according to the PR(3443) class and the data reproduced according to the PR(12221) class using a predetermined evaluation index. The PR class with a better evaluation index is selected and determined as the optimum PR class. The determination is made by the optimum PR class determination unit 46. Furthermore, the system controller 50 performs the switching control operation for switching the mode between the optimum PR class determination mode and the normal reproducing mode.

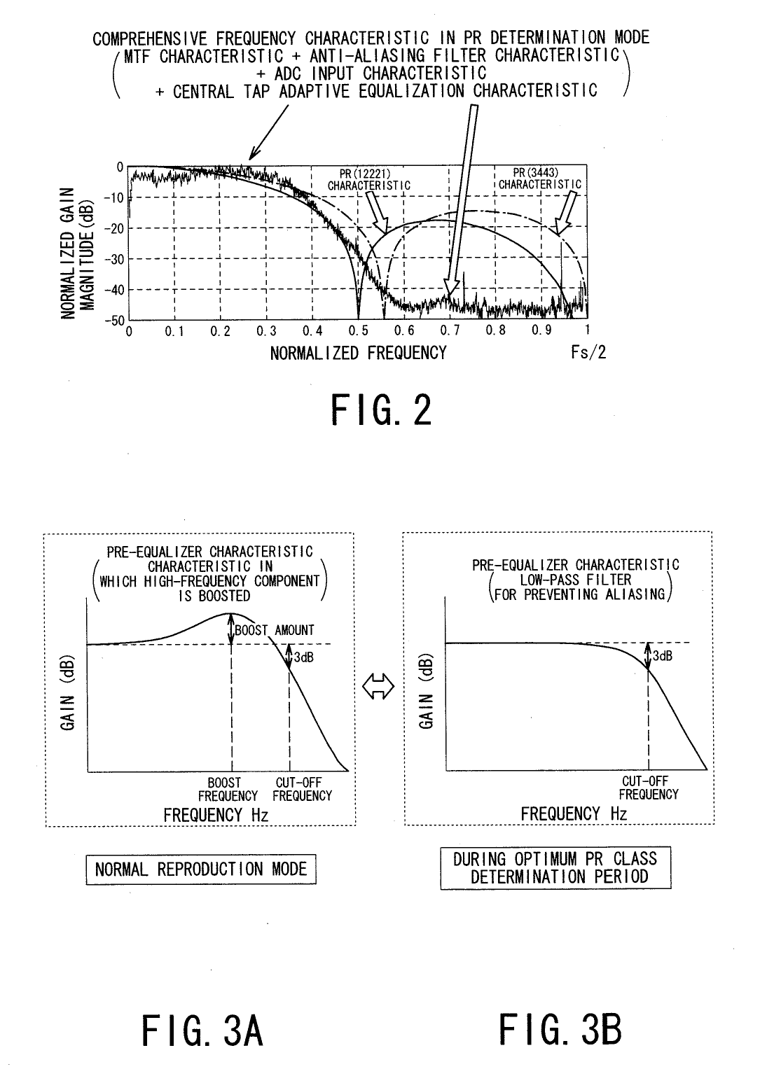

FIG. 2 is a diagram which shows the frequency characteristics of the PR(3443) class and the PR(12221) class, in addition to the MTF characteristic. Here, the term “MTF characteristic” as used here represents the comprehensive frequency characteristic including the frequency characteristic of the reproducing device side such as the PUH 10, the preamplifier 11, etc., in addition to the frequency characteristic of the optical disc D. In a strict sense, “MTF characteristic” as used here also includes the frequency characteristics of the amplitude control circuit 13 and the AD conversion unit 14.

Also, in a case in which the optical disc D is a recordable optical disc, the frequency characteristic of the optical disc D also includes the effects of the recording parameters, etc., which have been determined in the recording learning.

In general, “MTF characteristic” also includes the frequency characteristics of the pre-equalizer 12 and the adaptive equalization unit 30. However, with the present embodiment, in the optimum PR class determination mode, the frequency characteristics of the pre-equalizer 12 and the adaptive equalization unit 30 are set to respective values that differ from those set in the normal reproducing mode such that MTF characteristic as “raw” as possible is obtained at the input terminals of the Viterbi decoding unit 43 and the optimum determination unit 46. Here, the MTF characteristic that does not involve the effects of the frequency characteristics of the pre-equalizer 12 and the adaptive equalization unit 30 will be referred to as “raw MTF characteristic”. The adaptive equalization unit 30 compensates for the frequency characteristic of the input signal of the adaptive equalization unit 30 such that the frequency characteristic of the assumed PR class approximately matches the “raw MTF characteristic” (equalization to the PR class). However, in a case in which the compensation amount is excessively large, for example, in a case in which the compensation is performed involving extreme high-frequency boosting, high-frequency noise increases, leading to poor reproducing performance.

With the optical disc reproducing device 1 according to the present embodiment, the adaptive equalization unit 30 compensates for the frequency characteristics such that the effects of the compensation are as small as possible. To realize such an arrangement, in a case in which there is a large difference between the “raw MTF characteristic” and the frequency characteristic of the assumed PR class, a PR class having a frequency characteristic close to that of the “raw MTF characteristic” is selected and determined as the optimum PR class.

For this purpose, in the optimum PR class determination mode in which the optimum PR class is determined, the frequency characteristics of the pre-equalizer 12 and the adaptive equalization unit 30 are switched to the frequency-independent characteristics, i.e., the flat frequency characteristics, thereby inputting “MTF characteristics” as raw as possible to the Viterbi decoding unit 43 and the optimum class determination unit 46. It should be noted that the pre-equalizer 12 also provides a function of anti-aliasing. Accordingly, the pre-equalizer 12 has a low-pass filter characteristic in which around half of the sampling frequency is set to the cut-off frequency.

The method used in the adaptive equalization unit 30 for flattening the frequency characteristic is not restricted in particular. For example, a simple and effective method is that, from among multiple taps, the signal is passed through only the central taps.

FIG. 2 shows the MTF characteristic when the aforementioned frequency flattening settings are made for the pre-equalizer 12 and the adaptive equalization unit 30, i.e., the frequency characteristic thereof is set to that as close to the “raw MTF frequency” as possible.

As can be understood from FIG. 2, it is difficult to determine which of the PR(3443) characteristic and the PR(12221) characteristic is closer to the “raw MTF characteristic” based upon only the frequency characteristic.

With the present embodiment, the reproduced signal with the “raw MTF frequency” is applied to both the PR(3443) characteristic and the PR(12221) characteristic. Then, determination is made regarding which of these PR classes is suitable, based upon the magnitude of a predetermined reproduction quality evaluation index. Examples of the predetermined reproduction quality evaluation indexes include PRSNR (Partial Response Signal to Noise ratio), SbER (Simulated bit Error Rate), etc. These reproduction quality evaluation indexes are quality evaluation indexes calculated based upon the equalization error (difference between the output of the adaptive equalization unit 30 and the ideal response signal with respect to the decoded binary data). Detailed description is made in JP-A 2005-346847 and JP-A 2004-327013, etc., regarding the specific definition and calculation method, and accordingly, description thereof will be omitted. Alternatively, the square mean value of the equalization error values or the like may be employed as the reproduction quality evaluation index.

Detailed description will be made with reference to FIG. 1 etc., regarding the above-described method for determining the optimum PR class and the operation of the optical disc reproducing device 1 related to this method.

The PUH 10 emits the laser light to the recording medium D with a laser power for reproduction, and detects the reflected light from the recording medium D, thereby outputting an analog reproduced signal. The analog reproduced signal output from the PUH 10 is transmitted to the preamplifier 11, and the analog reproduced signal thus transmitted is subjected to processing such as signal amplification, etc.

In the next step, the variable-characteristic supporting pre-equalizer 12 performs predetermined waveform equalization in the normal reproduction mode. The waveform equalization characteristic is the frequency characteristic of an analog filter comprising a seventh-order equi-ripple filter. The frequency characteristic is defined by the cut-off frequency, boost frequency, boost amount, etc.

FIG. 3A is a diagram which shows an example of the frequency characteristic of the variable-characteristic supporting pre-equalizer 12 in the normal reproducing mode. As shown in the drawing, in this frequency characteristic, the high-frequency component is boosted. The boosted frequency component corresponds to the frequency component with a short code length such as 2 T or the like. In order to properly detect a channel clock in the downstream components, i.e., in the frequency detector 23 and the phase comparator 24 (timing recovery processing unit 20), the amplitude component of a short code length is important. Accordingly, in the normal reproduction mode, the frequency characteristic is used in which such a high-frequency component is boosted.

On the other hand, FIG. 3B is a diagram which shows an example of the frequency characteristic of the variable-characteristic supporting pre-equalizer 12 in the optimum PR class determination mode (during the period in which the optimum PR class is determined). As described above, it is important that, in the optimum PR class determination mode, “an MTF characteristic as raw as possible” is transmitted to the downstream components. Accordingly, the flat frequency characteristic that involves no boost characteristic is employed as shown in FIG. 3B. It should be noted that there is a need to set band limiting in order to prevent aliasing due to sampling operation. Accordingly, the low-pass filter property is employed with the cut-off frequency of approximately the half of the sampling frequency.

After the amplitude control circuit 13 adjusts the signal amplitude of the output signal of the variable-characteristic supporting pre-equalizer 12, the AD conversion unit 14 converts the analog reproduced signal into digital values.

With such an arrangement, the timing recovery processing unit 20 extracts a clock signal from the reproduced signal itself such that a suitable sampling timing is obtained. That is to say, the frequency control operation and the phase control operation are performed for the reproduced signal so as to generate a sampling clock signal with the frequency and the phase synchronously with the reproduced signal. The frequency control operation and the phase control operation are performed by the frequency detector 23, the phase comparator 24, the loop filter 22, and the VCO (Voltage Controlled Oscillator) 21.

With the present embodiment, the timing recovery equalizer 25 is provided on the input sides of the frequency detector 23 and the phase comparator 24. As described above, in the optimum PR class determination mode, “an MTF characteristic as raw as possible” is transmitted to the downstream components. Accordingly, the frequency characteristic of the pre-equalizer 12 is set to a flat frequency characteristic that involves no boost characteristic.

Meanwhile, in the optimum PR class determination mode, there is also a need to perform the frequency control operation and the phase control operation. That is to say, there is a need to raise the amplitude of the 2 T code length etc., to a predetermined level. For this reason, the timing recovery equalizer 25 which has the frequency characteristic for enhancing the high-frequency component is provided. The timing recovery equalizer 25 comprises a digital filter including multiple taps with predetermined coefficients, for example.

The offset control circuit 41 and the asymmetry control circuit 42 perform digital waveform shaping processing on the reproduced signal thus AD converted. The offset control circuit 41 is a circuit which performs control operation so as to maintain the duty ratio of the signal component at a constant value, for example. The asymmetry control circuit 42 is a circuit which detects the asymmetry of the signal in the amplitude direction by performing average detection of the reproduced signal subjected to offset adjustment, for example, and which performs control operation so as to reduce the asymmetry thus detected.

In the next step, the waveform thus subjected to the digital waveform shaping by the offset control circuit 41 and the asymmetry control circuit 42 is input to the adaptive equalization unit 30. The adaptive equalization unit 30 comprises the FIR filter 31 and the equalization coefficient learning circuit 32. The FIR filter 31 is a non-recursive digital filter comprising multiple taps. The signal of each tap is weighted by an equalization coefficient updated by the equalization coefficient learning circuit 32. After the weighting processing, the signals of the multiple taps are summed.

As described above, in the optimum PR class determination mode, the frequency characteristic of the adaptive equalizer 30 is switched to the flat frequency characteristic. On the other hand, in the normal reproduction mode, adaptive learning processing is performed for the equalization coefficients such that the output of the adaptive equalization unit 30 approaches to the frequency characteristic of the optimum PR class determined in the optimum PR class determination mode.

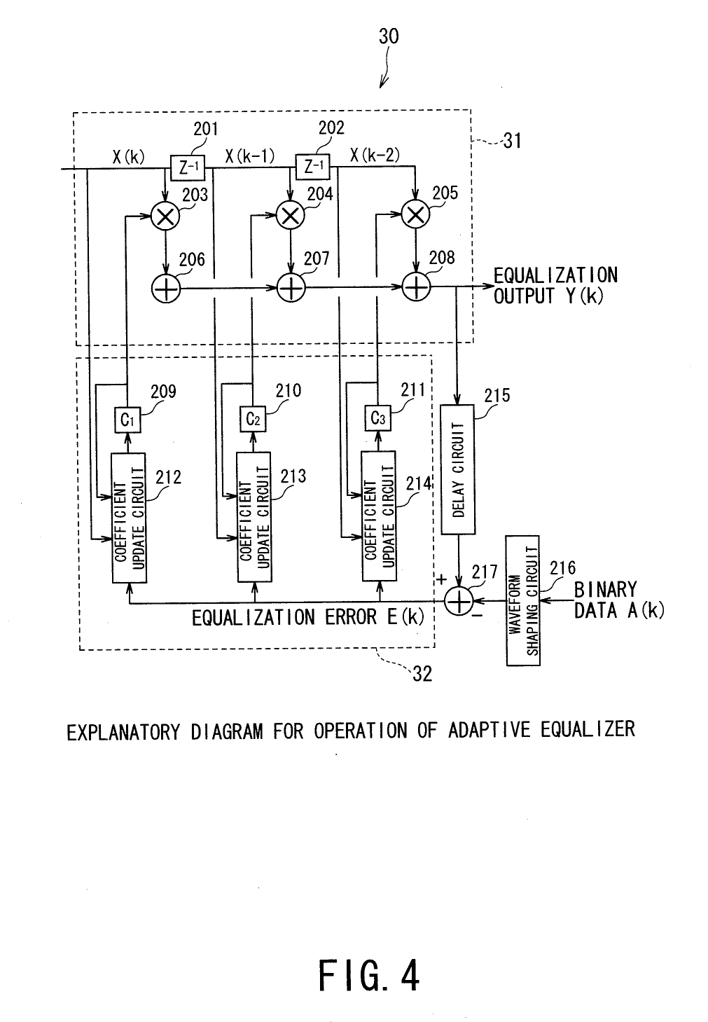

Specific configurations of adaptive learning processing are disclosed in many publicly known documents. Description will be made with reference to FIG. 4 regarding a learning method according to the LMS (Least Mean Square) algorithm which is the most ordinary algorithm.

FIG. 4 is a block diagram which shows a detailed configuration of the adaptive equalizer. The adaptive equalizer comprises the FIR filter 31 and the equalization coefficient learning circuit 32 shown in FIG. 1. In addition, the processing (for creating equalization error) performed in the optimum PR class determination unit 46 is shown for convenience of description.

In FIG. 4, each of one-clock delay units 201 and 202 comprises a flip-flop, which outputs an input signal with a delay of one clock. Each of multiplier circuits 203, 204, and 205 outputs the product of two input values. Also, each of adder circuits 206, 207, and 208 outputs the sum of two input values.

FIG. 4 shows an example of a 3-tap digital filter using three multipliers. Another arrangement may be made using a different number of multipliers, which performs the same basic operation. Here, description will be made below regarding the 3-tap digital filter.

Let us say that the input signal of the adaptive equalizing unit 30 at the point in time k is represented by x(k), and the multiplier factors input to the multiplier circuits 203, 204, and 205 are represented by c1, c2, and c3, respectively. In this case, the output Y(k) of the adaptive equalization unit 30 is represented by the following equation.

Y(k)=x(k)*c1+x(k−1)*c2+x(k−2)*c3 (Equation 1).

While the Y(k) is represented as described above, let us say that the binary data decoded by the Viterbi decoding unit 43 is represented by A(k). Furthermore, let us say that the optimum PR class thus determined is the PR(3443) class, for example, and A(k) is correct reproduced data. In this case, an ideal output Z(k) of the adaptive equalizer at the point in time k is represented by the following equation.

Z(k)=3*A(k)+4*A(k−1)+4*(k−2)+3*A(k−3)−7 (Equation 2).

Here, the equalization error E(k) at the point in time k is defined by the following equation.

E(k)=Y(k)−Z(k) (Equation 3).

In the adaptive learning, the coefficients of the respective multipliers are updated according to the following equations.

c1(k+1)=c1(k)−α*x(k)*E(k) (Equation 4)

c2(k+1)=c2(k)−α*x(k−1)*E(k) (Equation 5)

c3(k+1)=c3(k)−α*x(k−2)*E(k) (Equation 6)

The coefficient α in Equation 4 through Equation 6 is an update coefficient, which is set to a positive small value (e.g., 0.01). The processing represented by the aforementioned Equation 2 is performed by a waveform shaping circuit 216. A delay circuit 215 performs delay processing on the output Y(k) of the adder circuit 208 with a delay matching the processing time required in the Viterbi decoding unit 43. Then, an adder circuit 217 performs the processing represented by the aforementioned Equation 3. A coefficient update circuit 212 performs computation represented by Equation 4, thereby updating the coefficient for the multiplier 203. The update results are stored in a register 209. A coefficient update circuit 213 performs computation represented by Equation 5, thereby updating the coefficient for the multiplier 204. The update results are stored in a register 210. Similarly, a coefficient update circuit 214 performs computation represented by Equation 6, thereby updating the coefficient for the multiplier 205. The update results are stored in a register 211.

As described above, in the normal reproduction mode, the adaptive equalization processing is performed with respect to the optimum PR class (PR(3443) class in the aforementioned example) determined in the optimum PR class determination mode. The output signal thus subjected to the adaptive equalization processing is input to the Viterbi decoding unit 43. The Viterbi decoding unit 43 performs maximum likelihood estimation processing (Viterbi decoding) on the input data, thereby outputting the binary data A(k). With such an arrangement, the PR class used in the Viterbi decoding unit 43 is also the optimum PR class thus determined in the optimum PR class determination mode.

On the other hand, as described above, the frequency characteristic of the adaptive equalization unit 30 is set to a flat frequency characteristic, which is independent of the frequency, in the optimum PR class determination mode. Specifically, the equalization coefficient of each tap is fixed to zero, and learning is not performed, except for the central tap. With such an arrangement, adaptive learning is performed for only the equalization coefficient of the central tap. In this case, learning is performed with respect to only the gain, and the frequency characteristic is set to a flat frequency characteristic which is independent of the frequency. As a result, the input signal which has the frequency characteristic with approximately the “raw MTF characteristic” maintained is input to the adaptive equalization unit 30 and the optimum PR class determination unit 46.

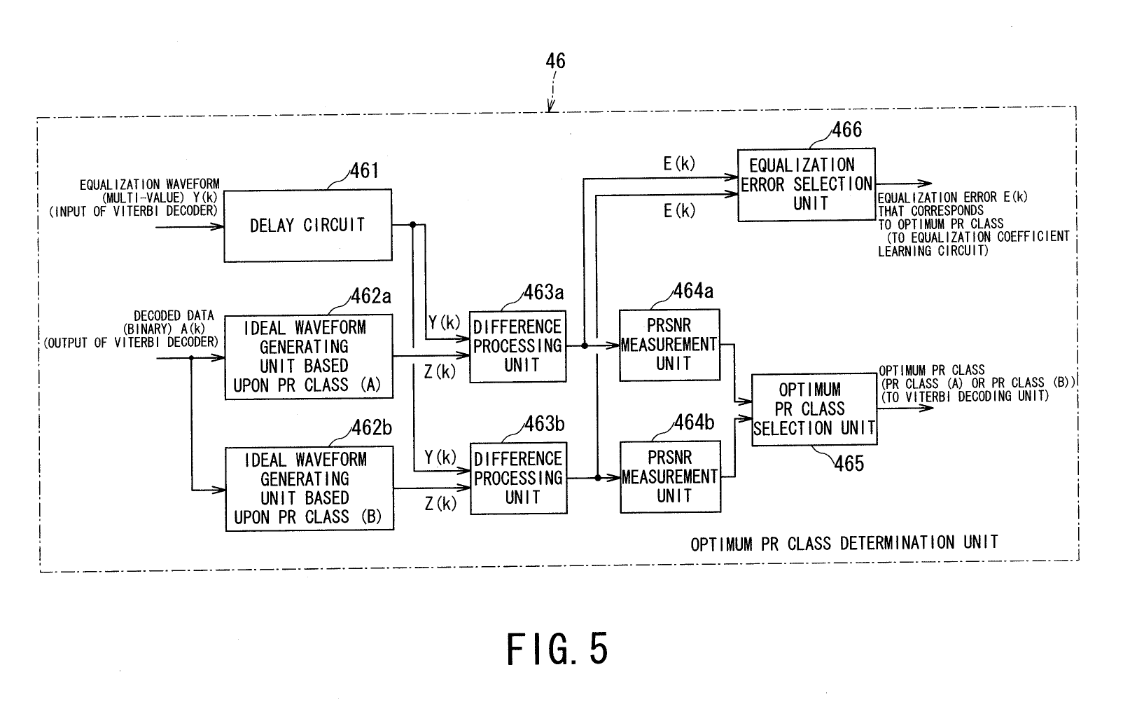

FIG. 5 is a block diagram which shows a detailed configuration example of the maximum PR class determination unit 46. The optimum PR class determination unit 46 selects and determines the optimum PR class from among multiple PR classes (two PR classes, i.e., PR(3443) class and PR(12221) class in this example).

The optimum PR class determination unit 46 has a configuration including a delay circuit 461, ideal waveform generating units 462a and 462b, difference processing units 463a and 463b, PRSNR measurement units 464a and 464b, an optimum PR class selection unit 465, and an equalization error selection unit 466.

The binary data A(k) decoded by the Viterbi decoding unit 43 is input to the ideal waveform generating units 462a and 462b. Of these units, the ideal waveform generating unit 462a generates an ideal response waveform Z(k) based upon a PR class (A) (e.g., PR(3443) class). The ideal response waveform Z(k) is calculated using the same computation represented by Equation 2. On the other hand, the ideal waveform generating unit 462b generates an ideal response waveform Z(k) based upon a PR class (B) (e.g., PR(12221) class). Also, in this case, the ideal response waveform Z(k) is calculated according to a similar computation Equation to Equation 2.

The difference processing unit 463a obtains the equalization error E(k) based upon the difference between the ideal response waveform Z(k) generated based upon the PR class (A) and the equalization waveform Y(k). The equalization waveform Y(k) is the same as the waveform of the input signal of the Viterbi decoding unit 43. The delay circuit 461 compensates for the processing delay that occurs in the Viterbi decoding unit 43. In the same way, the difference processing unit 463b obtains the equalization error E(k) based upon the difference between the ideal response waveform Z(k) generated based upon the PR class (B) and the equalization waveform Y(k).

The PRSNR measurement units 464a and 464b calculate the PRSNR for the PR class (A) and the PRSNR for the PR class (B) based upon the equalization errors E(k), respectively.

These PRSNR values are input to the optimum PR class selection unit 465, and the optimum PR class is determined based upon which PRSNR is greater. Specifically, of the PRSNR obtained by applying the PR(3443) class and the PRSNR obtained by applying the PR(12221) class, the PR class that corresponds to the greater PRSNR is determined to be the optimum PR class. After the determination of the optimum PR class, the optimum PR class determination mode ends, whereupon the system controller 50 instructs each component to switch the mode to the normal reproduction mode.

Of the components of the optimum PR class determination unit 46, the components other than the PRSNR measurement units 464a and 464b and the optimum PR class selection unit 465 also operate in the normal reproduction mode. It should be noted that only the equalization error that corresponds to the PR class selected as the optimum PR class is selected, and the equalization error thus selected is output to the equalization coefficient learning circuit 32 of the adaptive equalization unit 30. The selection of the equalization error is performed by the equalization error selection unit 466.

Description has been made with reference to FIG. 5 regarding an arrangement in which parallel processing can be performed for multiple PR classes. Alternatively, an arrangement may be made in which the processing is performed for multiple PR classes in a time-shared manner, thereby sequentially obtaining the PRSNR values. With such an arrangement, the multiple PRSNR values thus obtained are stored as appropriate. When the PRSNR values for all the PR classes are obtained, i.e., in the final stage, the magnitude determination for PRSNR is performed, and the optimum PR class should be determined based upon the magnitude determination results.

With the optical disc reproducing device 1 according to the first embodiment, reproduction operation is actually performed for the optical disc, and the optimum PR class is determined based upon the reproduced signal, instead of selecting the PR class based upon the standard of the optical disc. Thus, the optimum PR class can be selected and determined, which matches the comprehensive MTF characteristic including the frequency characteristic of the reproducing device side, the frequency characteristic resulting from the recording learning, etc., in addition to the frequency characteristic of the optical disc itself.

Furthermore, the frequency characteristic of the optimum PR class thus determined matches the comprehensive MTF characteristic with a high degree of approximation. Thus, such an arrangement does not involve unnecessary high-frequency boost etc., in the adaptive equalization unit 30, thereby preventing reduction in the quality of the reproduced signal.

Furthermore, in the optimum PR class determination mode in which the optimum PR class is determined, control operation is performed so as to maintain the frequency characteristics of the pre-equalizer 12 and the adaptive equalization unit 30 at flat frequency characteristics. Thus, the optimum PR class can be determined with high precision based upon the “raw MTF characteristic”.

### (2) Second Embodiment

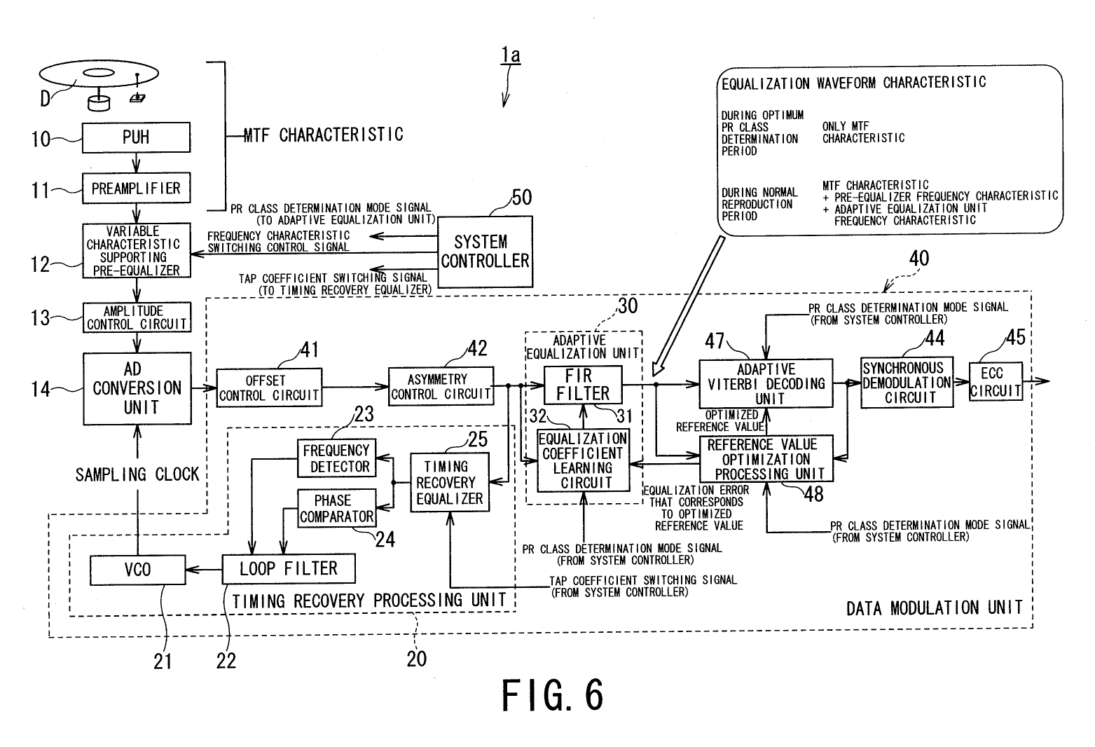

FIG. 6 is a block diagram which shows a configuration example of an optical disc reproducing device 1a according to a second embodiment. With the first embodiment, the optimum PR class for the Viterbi decoding processing is selected from among multiple “discrete PR classes”. Here, the term “discrete PR classes” represent PR classes each of which provides an impulse response (response waveform that corresponds to an input signal with the amplitude of “1” and the code length of 1 T) with fixed integers such as (“3”, “4”, “4”, “3”) or (“1”, “2”, “2”, “2”, “1”). Examples of such discrete PR classes include the aforementioned PR(3443) class and PR(12221) class. Also, in a case of employing the “discrete PR classes”, with respect to an input signal with a desired code length according to the modulation rule (1,7) RLL, for example, the amplitude of the response signal (the amplitude of the response signal will be referred to as “reference value” hereafter) is an integer, and the number of possible integers is limited.

On the other hand, the second embodiment differs in that adaptive Viterbi decoding processing is performed instead of the Viterbi decoding processing. Adaptive Viterbi processing allows the maximum likelihood decoding processing to be performed based upon an “intermediate PR class”. In the “intermediate PR class”, the aforementioned reference value is not necessarily an integer, and can be an intermediate value (real number). Thus, the adaptive Viterbi decoding processing provides the “intermediate PR class” which is flexibly adjusted to the MTF characteristic of the input signal.

With the second embodiment, the PR class that corresponds to the MTF characteristic of the reproduced signal can be set to the optimum “intermediate PR class”. Specifically, the reference value used in the Viterbi decoding processing is set to the optimum values, thereby obtaining the optimum “intermediate PR class”.

Brief description will be made below regarding the adaptive Viterbi decoding processing. With the second embodiment, the adaptive Viterbi decoding processing is provided by an adaptive Viterbi decoding unit 47 and a reference value optimization processing unit 48.

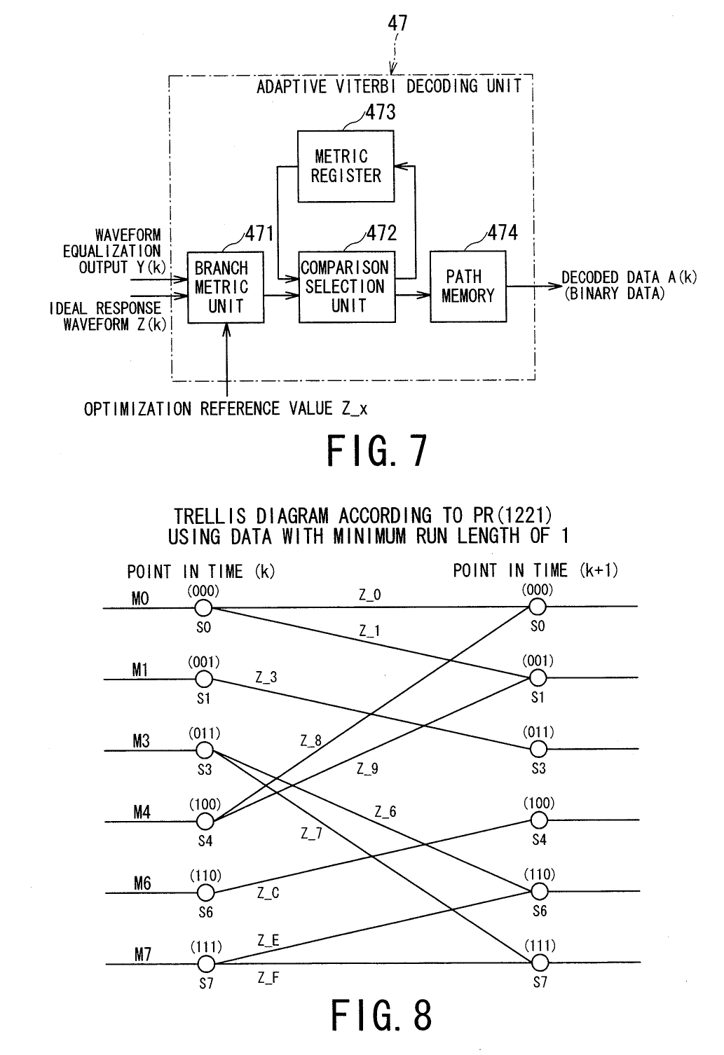

FIG. 7 is a diagram which shows a configuration example of the adaptive Viterbi decoding unit 47. The adaptive Viterbi decoding unit 47 comprises a branch metric unit 471, a comparison selection unit 472, a metric register 473, and a path memory 474. The branch metric unit 471 generates branch metrics BM_0 to BM_F based upon the output signal Y(k) output from the adaptive equalization unit 30 and the output signal Z(k) output from the reference value optimization processing unit 48. The comparison selection unit 472 computes the accumulated metric based upon the output of the branch metric unit 471 and the output of the metric register 473, and performs comparison selection processing.

The accumulated metric thus selected is temporarily held by the metric register 473, and is used in the comparison selection processing at the next time. The path memory 474 holds the past comparison selection results, and outputs the binary data A(k) in the final stage.

Next, detailed description will be made regarding the branch metric unit 471 with reference to an example of a 6-state Trellis diagram. FIG. 8 shows an example of the Trellis diagram according to the PR(1221) class using data with the minimum run length of 1. In a case in which the PR(1221) class is employed for the data with the minimum run length of 1, possible internal states are (000), (001), (011), (100), (110), and (111), and accordingly, the number of the internal states is 6. In FIG. 8, the internal states are represented by S0, S1, S3, S4, S6, and S7, respectively. The state at the point in time k and the state at the point in time k+1 are connected to each other by a branch. The branches are represented by Z_0, Z_1, Z_3, Z_6, Z_7, Z_8, Z_9, Z_C, Z_E, and Z_F, respectively. As shown in FIG. 8, the branch that connects the state S0 at the point in time k to the state S0 at the point in time k+1 is Z_0. Similarly, the branch that connects S0 to S1 is Z_1. The branch that connects S1 to S3 is Z_3. The branch that connects S3 to the S6 is Z_6. The branch that connects S3 to S7 is Z_7. The branch that connects S4 to S0 is Z_8. The branch that connects S4 to S1 is Z_9. The branch that connects S6 to S4 is Z_C. The branch that connects S7 to S6 is Z_E. The branch that connects S7 to S7 is Z_F.

In a case in which the partial response of the class PR(1221) is employed, the reference value (ideal channel response) Z is obtained by performing convolution computation of the input binary data sequence A based upon the PR class. That is to say, the reference value Z is obtained by the following equation.

Z=A*[1221] (Equation 7)

Here, the symbol “*” is an operator which represents the convolution computation. The input binary data sequence A is composed of 4-bit serial binary data with the minimum run length of 1. Accordingly, there are ten kinds of combinations as follows.

A=[0000], [0001], [0011], [0110], [0111], [1000], [1100], [1110], [1111] (Equation 8)

Since there are ten kinds of input binary data sequences A (which correspond to the respective branches shown in FIG. 8), there are, theoretically, ten kinds of reference values Z according to the branches. However, there are duplicate values in the convolution computation results. Accordingly, in reality, there are seven kinds of reference values.

At each point in time, the branch metric unit 471 computes the distance between the channel output Y(k) and the reference value Z as the branch metric BM. That is to say, the branch metric unit 471 performs computation according to the following equation.

BM_{—}x=(Y(k)−Zx)² (Equation 9)

Here, the index x in the BM_x and Zx corresponds to the index x of each branch Z_x shown in FIG. 8.

The branch metric BM is obtained according to Equation 9 for each branch thus obtained according to Equation 7. The branch metric unit 471 outputs the results thus obtained.

Here, let us consider a case in which, in the calculation of Z according to Equation 7, linearity is not satisfied (non-linear). Let us consider an arrangement in which, even in such a case, the reference value Z can be obtained based upon the input binary data sequence A with a limited length. Furthermore, let us consider an arrangement in which the ideal channel response Z is determined based upon the 4-bit serial binary data sequence A as in Equation 8, for simplification of description. With such an arrangement, the following equation is satisfied.

Z=TLU(A) (Equation 10)

Here, the symbol “TLU” represents a table-lookup function, which is generally realized by memory or the like. In the same way as in Equation 7, there are ten kinds of input binary data sequences A. Accordingly, there are ten kinds of Z according to Equation 10. The branch metric BM is computed according to Equation 9 with respect to each Z obtained according to Equation 10. As described above, the branch metric can be properly defined with respect to the channel response which cannot be represented by convolution computation.

In order to perform the maximum likelihood decoding in a table-lookup manner as described above, there is a need to obtain the table-lookup function TLU that corresponds to the actual MTF characteristic. With the optical disc reproducing device 1a according to the second embodiment, the table-lookup function TLU is obtained by the adaptive control operation based upon the actual MTF characteristic.

First, the table-lookup function represented by Equation 10 is defined using the convolution computation Equation represented by Equation 7. Let us say that, at the point in time k, the Viterbi decoding unit 47 outputs the binary data sequence A of [0000]. In this case, according to Equation 10, the reference value Z_0(k) at the point in time k is obtained.

Z_{—}0(k)=TLU(A[0000])

With the output of the adaptive equalization unit 30 as Y(k), the equalization error E(k) is obtained according to the following Equation.

E(k)=Y(k)−Z_{—}0(k) (Equation 11).

In this stage, in order to perform the adaptive control operation for the table-lookup function TLU, the following processing is performed.

Z_{—}0(k+1)=Z_{—}0+α·E(k) (Equation 12)

The coefficient α in Equation 12 is an update coefficient as in Equation 4 through Equation 6, which is set to a positive and small value (e.g., 0.01). Each of the indexes k and k+1 represents the point in time. The Equation 12 means that the value of Z_0 is updated according to the elapse of time.

In the same way, at a given point in time k, when the binary data sequence A output from the adaptive equalization unit 30 is [0001], the same processing as represented by Equation 12 is performed, thereby updating the value of Z_1. Subsequently, the values of Z_x(k) that correspond to the value of the binary data sequence A thus obtained are updated. Thus, the table-lookup function TLU is gradually optimized such that the table-lookup function TLU matches the actual MTF characteristic.

It should be noted that, with the present embodiment, limitation is employed in which, when the binary data sequence A is [0000] or [1111], the computation represented by Equation 12 is not performed, and accordingly, the values of Z_0 and Z_F are not updated. Such limitation allows the table-lookup function to converge to an optimum value with a simple configuration.

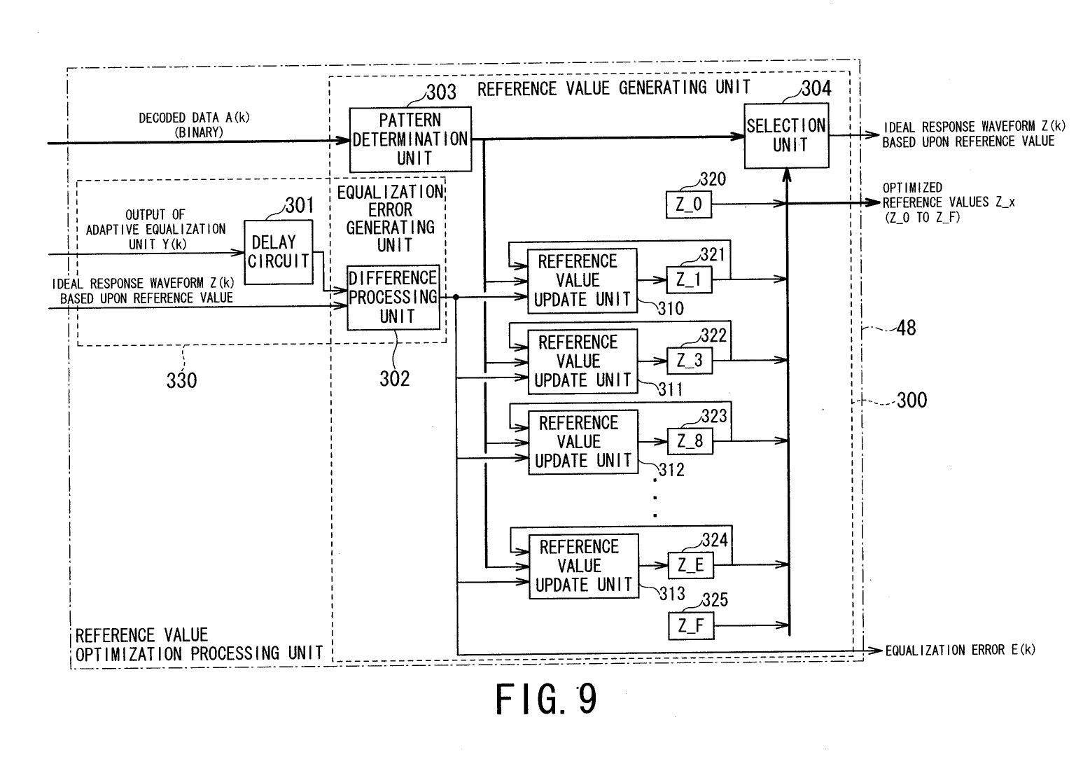

FIG. 9 is a diagram which shows a configuration example of the reference value optimization processing unit 48 which provides the above-described processing. The reference value optimization processing unit 48 comprises a reference value generating unit 300 and an equalization error generating unit 330.

A pattern determination unit 303 of the reference value generating unit 300 determines which pattern represented by Equation 8 matches the past 4-bit pattern, using the decoded data (binary data) A(K) output from the Viterbi decoding unit 47 as the input. Each of reference value registers 320 through 325 is a register which holds the output of the table-lookup function TLU represented by Equation 10. In practice, such an arrangement requires ten reference value registers Z_0 through Z_F. However, FIG. 9 shows only six reference value registers Z_0, Z_1, Z_3, Z_6, Z_E, and Z_F, for omitting redundant description. The outputs of the reference value registers 320 through 325 are collected and transmitted to the Viterbi decoding unit 47 in the form of the reference value table Z_x. Furthermore, the selection unit 304 selects one reference value according to the output of the pattern determination unit 303, and outputs the reference value thus selected as the Z(k). Each of the reference value update units 310 through 313 performs the reference value update processing represented by Equation 12. In practice, such an arrangement requires eight reference value update units. However, FIG. 9 shows only four reference value registers for omitting redundant description as the reference value registers are shown. Each of the reference value update units 310 through 313 is connected to the equalization error signal E(k), the reference register value Z_x, and the output of the pattern determination unit 303. When the pattern determination unit 303 selects one pattern, the reference value update processing, which is represented by Equation 12, is performed.

The equalization error generating unit 330 comprises a delay circuit 301 and a difference processing unit 302. The delay circuit 301 delays the output Y(k) of the adaptive equalization unit 30 by a predetermined period of time. Then, the reference value (ideal response waveform) Z(k) is subtracted from the output Y(k) of the adaptive equalization unit 30 thus delayed, thereby obtaining the equalization error represented by Equation 11.

With the second embodiment, switching to the optimum PR class determination mode is performed by the system controller 50. When the optical disc D is inserted into the optical disc reproducing device 1a, first, disc identification is executed, whereupon the device identifies the standard of the optical disc thus inserted. Next, the system controller 50 selects a suitable and settable constraint length and initial PR class. The term “constraint length” as used here represents the filter length provided according to the PR class. For example, when the PR(1221) class or the PR(3443) class is employed, the constraint length is set to the same value, i.e., 4. Description will be made below regarding an arrangement employing the initial PR class of PR(3443) with the constraint length of 4, for simplification of description.

After the current mode is switched to the optimum PR class determination mode according to an instruction from the system controller 50, in the same way as in the first embodiment, control operation is performed such that the frequency characteristic of the pre-equalizer 12 and the frequency characteristic of the adaptive equalization unit 30 exhibit flat characteristics. Furthermore, the update processing for the reference value table Z_x as described above is started, and control operation is performed such that the reference value Z_x is set to the optimum value matching the MTF characteristic.

When the PR(3443) class, which is a “discrete PR class”, is employed, and the reference value is represented in the form of a 7-bit value, there are seven kinds of levels of −49, −28, −7, 0, 7, 28, and 49. It should be noted that the amplitude level for the 2 T code length corresponds to the inputs of −7 to +7. Similarly, when the PR(1221) class is employed, and the reference value is represented in the form of a 7-bit value, there are seven kinds of levels of the reference values, i.e., −48, −32, −16, 0, 16, 32, and 48.

Let us consider a case in which the initial PR class is set to the PR(3443) class, and as a result of updating the reference value table Z_x, the reference value converges to an intermediate value near the reference value according to the PR(1221) class. Such a situation means that the frequency characteristic changes such that the cutoff shifts from that according to the PR(3443) to a higher-frequency region.

After the reference value is updated during a predetermined period such that it converges to the optimum value, the system controller 50 stops the adaptive control operation, and fixes the reference value thus converged. Subsequently, the current mode is returned to the normal reproduction mode.

The second embodiment provides “intermediate PR class” in a range of the same constraint length while maintaining the same constraint length. This provides the highly flexible optimum PR class with a higher degree of approximation as to the actual MTF characteristic.

### (3) Third Embodiment

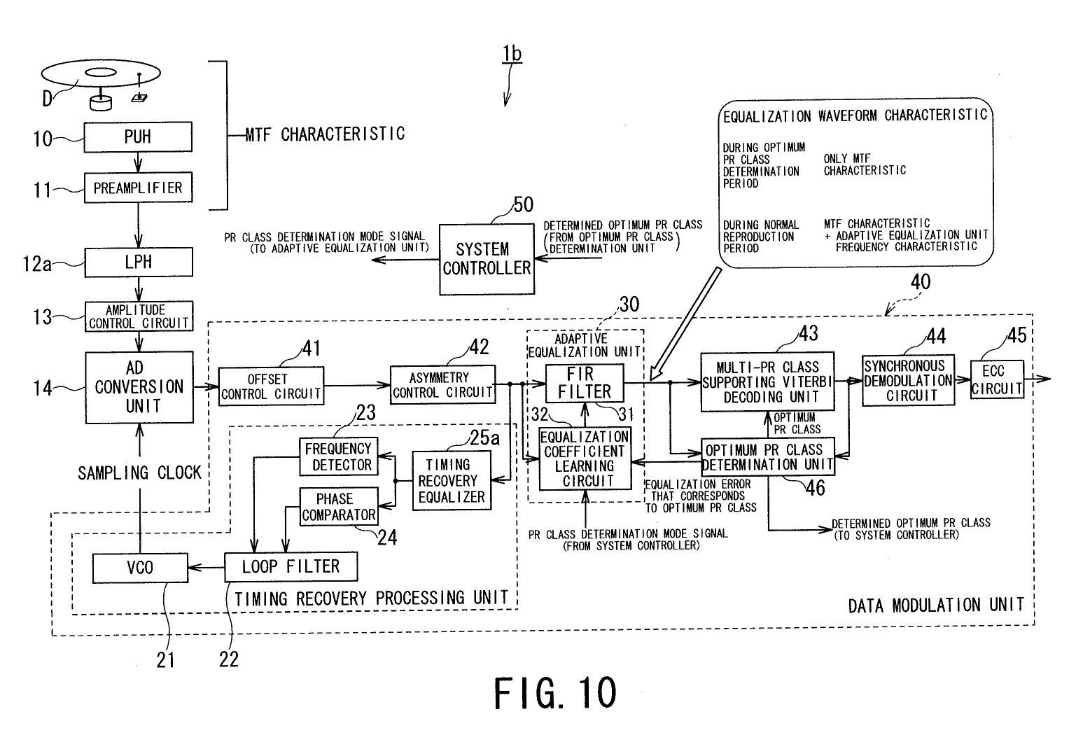

FIG. 10 is a diagram which shows a configuration example of an optical disc reproducing device 1b according to a third embodiment. The basic configuration of the third embodiment is the same as that of the first embodiment. The difference point is that an LPF 12a, which has a flat frequency characteristic in order to perform only anti-aliasing, is employed in the third embodiment instead of the pre-equalizer 12 employed in the first embodiment. Together with this, the frequency characteristic of a timing-recovery equalizer 25a is set to a fixed frequency characteristic in which the high-frequency range is boosted at all times.

In order to provide the boost characteristic as shown in FIG. 3A, the conventional pre-equalizer 12 comprises a high-order (e.g., seventh-order) equi-ripple filter or the like. In general, such a high-order equi-ripple filter has a complicated configuration, which requires long adjustment time for adjusting the frequency characteristic with high precision, leading to high costs.

On the other hand, the circuit scale of an analog low-pass filter having a simple configuration for the purpose of anti-aliasing alone can be reduced to a fraction of the scale of the conventional high-order equi-ripple filters. This markedly reduces the part costs.

The optical disc reproducing device 1b according to the third embodiment provides reduced costs, as well as providing the same advantage as that of the first embodiment.

It should be noted that, for the optical disc reproducing device 1a according to the second embodiment having the adaptive Viterbi decoding unit 47, the simple analog low-pass filter LPF 12a may also be employed instead of the boost-type pre-equalizer 12. Such an arrangement also provides the reduced costs.

As described above, with the optical disc reproducing devices 1, 1a, and 1b, and the optical disc reproducing methods according to the above-described embodiments, the optimum PR class can be set for the comprehensive frequency characteristic of an optical disc including the recording characteristic and the reproducing characteristic. This improves the quality of the reproduced signal. Furthermore, this reduces the costs.

It should be noted that the above-described embodiments according to the present invention are by no means intended to be interpreted restrictively. Rather, in the stage of the embodiment, various modifications may be made without departing from the sprint of the present invention. Also, various embodiments may be made according to the present invention by making appropriate combinations of multiple components disclosed in the above-described embodiments. For example, components may be eliminated as appropriate from all the components described in each embodiment. Also, an appropriate combination of the components may be made over different embodiments.

What is claimed is:

1. An optical disc reproducing device configured to perform reproduction from an optical disc using a Partial Response Maximum Likelihood (PRML) method, comprising a Viterbi decoder configured to generate binary data using the maximum likelihood decoding based upon reproduced data obtained by sampling a reproduced signal from the optical disc,
wherein the Viterbi decoder is configured to generate the binary data based upon an optimal Partial Response (PR) class determined based upon the reproduced data and the binary data in a predetermined determination period.

2. The optical disc reproducing device of claim 1, further comprising a PR class determination module configured to determine the optimal PR class,
wherein the PR class determination module is configured to set a plurality of PR classes beforehand, to obtain a plurality of substantial response data that corresponds to the plurality of the PR classes based upon the binary data, to calculate a plurality of evaluation indices based upon the differences between the reproduced data that correspond to the binary data and the plurality of substantial response data respectively, and to determine the optimal PR class by selecting one from among the plurality of PR classes based upon the plurality of evaluation indices.

3. The optical disc reproducing device of claim 2, wherein the evaluation indices represent Partial Response Signal to Noise ratio (PRSNR),
and wherein the PR class determination module is configured to determine the PR class that exhibits the greatest PRSNR to be the optimal PR class.

4. The optical disc reproducing device of claim 1, further comprising:
an Analog to Digital (A/D) convertor configured to perform an A/D conversion by sampling the reproduced signal;
an analog filter provided upstream of the A/D convertor, and configured to boost a high-frequency component of a signal; and
an adaptive equalizer provided between the A/D convertor and the Viterbi decoder, and configured as a non-recursive digital filter comprising multiple taps,
wherein the frequency characteristics of the analog filter comprise a low-pass filter characteristic with a substantially flat pass-band response in order to prevent aliasing, and the adaptive equalizer comprises a digital filter characteristic with a substantially flat pass-band response during the determination period.

5. The optical disc reproducing device of claim 1, wherein the Viterbi decoder is an adaptive Viterbi decoder,
and wherein the adaptive Viterbi decoder is configured to update and to optimize a reference value to be used in the maximum likelihood decoding, based upon the reproduced data and the binary data during the predetermined determination period,
and wherein the optimal PR class is a PR class represented by the optimized reference value.

6. The optical disc reproducing device of claim 5, further comprising:
an A/D convertor configured to perform an A/D conversion by sampling the reproduced signal;
an analog filter provided upstream of the A/D convertor, and configured to boost a high-frequency component of a signal; and
an adaptive equalizer provided between the A/D convertor and the Viterbi decoder, and configured as a non-recursive digital filter comprising multiple taps,
wherein the frequency characteristics of the analog filter comprise a low-pass filter characteristic with a substantially flat pass-band response in order to prevent aliasing, and the adaptive equalizer comprises a digital filter characteristic with a substantially flat pass-band response during the determination period.

7. The optical disc reproducing device of claim 1, further comprising:
an A/D convertor configured to perform an A/D conversion by sampling the reproduced signal;
a timing recovery processor configured to generate a sampling clock used in the A/D conversion, by performing phase locking and frequency locking on the output signal of the A/D convertor;
an analog filter provided upstream of the A/D convertor, with frequency characteristics comprising a low-pass filter characteristic with a substantially flat pass-band response in order to prevent aliasing; and
a digital filter provided between the A/D convertor and the timing recovery processor, configured to boost a high-frequency component.

8. An optical disc reproducing method for performing reproduction from an optical disc using a PRML method, comprising the steps of:
generating binary data using maximum likelihood decoding by means of Viterbi decoding based upon reproduced data obtained by sampling a reproduced signal from the optical disc,
wherein the binary data is generated based upon an optimal PR class determined based upon the reproduced data and the binary data in a predetermined determination period in the step of generating binary data.

9. The optical disc reproducing method of claim 8, further comprising:
determining the optimum PR class; wherein the determining comprises:
setting a plurality of PR classes;
obtaining substantial response data that corresponds to the plurality of the PR classes based upon the binary data;
calculating a plurality of evaluation indices based upon the differences between the reproduced data that correspond to the binary data and the plurality of substantial response data respectively; and
determining the optimal PR class by selecting one from among the plurality of PR classes based upon the plurality of evaluation indices.

10. The optical disc reproducing method of claim 9, wherein the evaluation indices represent PRSNR, the determination step further comprises:
determining the PR class of the greatest PRSNR as the optimal PR class.

11. The optical disc reproducing method of claim 8, further comprising:
A/D converting the reproduced signal;
filtering an analog reproduced signal before the A/D conversion with a frequency characteristic configured to boost a high-frequency component during a period other than the determination period;
filtering the analog reproduced signal before the A/D conversion with a low-pass filter with a substantially flat pass-band response in order to prevent aliasing during the determination period; and
adaptive waveform equalizing performed on the plurality of reproduced data after the A/D conversion according to the optimal PR class during a period other than the determination period; and
applying a frequency-independent response over the entire band on the plurality of reproduced data after the A/D conversion during the determination period.

12. The optical disc reproducing method of claim 8, wherein:
the Viterbi decoding is adaptive Viterbi decoding;
a reference value used in the maximum likelihood decoding is updated and optimized based upon the plurality of reproduced data and the binary data in the adaptive Viterbi decoding during the predetermined determination period; and
the optimal PR class is a PR class represented by the optimized reference value.

13. The optical disc reproducing method of claim 12, further comprising:
A/D converting the reproduced signal;
filtering an analog reproduced signal before the A/D conversion with a frequency characteristic configured to boost a high-frequency component during a period other than the determination period;
filtering the analog reproduced signal before the A/D conversion with a low-pass filter with a substantially flat pass-band response in order to prevent aliasing during the determination period; and
adaptive waveform equalizing performed on the plurality of reproduced data after the A/D conversion according to the optimal PR class during a period other than the determination period; and
applying a frequency-independent response over the entire band on the plurality of reproduced data after the A/D conversion during the determination period.

14. The optical disc reproducing method of claim 8, further comprising:
filtering an analog reproduced signal before the A/D conversion with a low-pass filter with a substantially flat pass-band response;
A/D converting by sampling the filtered signal with the low-pass filter characteristic;
digital filtering the A/D converted signal in order to boost a high-frequency component; and
generating a sampling clock used in the A/D conversion, by phase locking and frequency locking on the high-frequency component boosted signal.
